(19) United States
(12) Patent Application Publication
(10) Pub. No.: US 2016/0274306 A1
(43) Pub. Date: Sep. 22, 2016

(54) OPTICAL TRANSMISSION APPARATUS AND TRANSMISSION METHOD THEREFOR

(71) Applicant: CANON KABUSHIKI KAISHA, Tokyo (JP)

(72) Inventor: Mitsuyoshi Yukawa, Tokyo (JP)

(21) Appl. No.: 15/066,850

(22) Filed: Mar. 10, 2016

(30) Foreign Application Priority Data
Mar. 17, 2015 (JP) 2015-054061
Jan. 25, 2016 (JP) 2016-011850

(51) Int. Cl. G02B 6/293; H01S 3/00; H01S 3/11; G02B 6/02

(52) U.S. Cl. CPC G02B 6/29394; G02B 6/02261; H01S 3/0057; H01S 3/0092; H01S 3/11

(57) ABSTRACT

An optical transmission apparatus for transmitting pulsed light includes a dispersion medium having a negative dispersion parameter in a wavelength band of incident pulsed light, a first fiber which receives the pulsed light that has passed through the dispersion medium and has a negative dispersion parameter in a wavelength band of the incident pulsed light, and a second fiber which receives the pulsed light that has passed through the first fiber and has a positive dispersion parameter in a wavelength band of the incident pulsed light. The dispersion medium and the second fiber have positive dispersion slopes. The first fiber has a negative dispersion slope.

### BACKGROUND OF THE INVENTION

1. Field of the Invention

The present invention relates to an optical transmission apparatus and a transmission method using an optical fiber.

2. Description of the Related Art

In the transmission of pulsed light through an optical fiber, dispersion of the optical fiber increases the pulse width of a pulse of light; this is known as spectral or pulse broadening. The shorter the pulse width of a short pulse of light, the larger the peak power intensity of the short pulse light. Therefore, at the time of propagation of short pulse light through an optical fiber, the pulse waveform of the short pulse light is sometimes changed because of nonlinear optical effects such as self-phase modulation (SPM). SPM-induced pulse broadening can degrade the performance of pulsed light transmission through an optical fiber system.

Examples of a method of suppressing these phenomena include a method of disposing, on a short pulse light propagation path, an optical element having dispersion of the opposite sign to that of dispersion of an optical fiber as a dispersion compensator. U.S. Pat. No. 6,249,630 discloses a method of entering short pulse light into an optical fiber via a dispersion compensator such as a diffraction grating. As disclosed in U.S. Pat. No. 6,249,630, before pulsed light enters an optical fiber, the pulse width of the pulsed light is increased and the peak power thereof is reduced by giving dispersion to the pulse light. As a result, the change in the pulse waveform of the pulse light due to a nonlinear optical effect is reduced. Furthermore, by adjusting the amount of dispersion prior to and subsequent to the optical fiber, compensation for dispersion can also be performed. As a dispersion compensator, a diffraction grating or a prism is used.

Short pulse light has an intensity spectrum over a wide wavelength band. In a case where such short pulse light is used, broadband dispersion compensation is needed. Accordingly, not only dispersion compensation at a specific wavelength but also compensation for a dispersion slope obtained by differentiating a dispersion parameter with respect to a wavelength is needed. If compensation for a dispersion slope is not performed, the temporal waveform of outgoing light output from an optical fiber becomes deformed and the peak power of the outgoing light pulse is reduced as compared with incident light input into the optical fiber. An example of this phenomenon is illustrated in FIG. 2. As a method of compensating for such a dispersion slope, U.S. Patent Application Publication No. 2012/0134011 discloses a method of providing an appropriate dispersion parameter and an appropriate dispersion slope for short pulse light using a nonlinear optical effect before transmitting the short pulse light through a fiber.

### SUMMARY OF THE INVENTION

The various embodiments of the present invention are directed to an optical transmission apparatus for transmitting pulsed light. In one embodiment, the optical transmission apparatus includes a dispersion medium having a negative dispersion parameter in a wavelength band of incident pulsed light, a first fiber which receives the pulsed light that has passed through the dispersion medium and has a negative dispersion parameter in a wavelength band of the incident pulsed light, and a second fiber which receives the pulsed light that has passed through the first fiber and has a positive dispersion parameter in a wavelength band of the incident pulsed light. The dispersion medium and the second fiber have positive dispersion slopes. The first fiber has a negative dispersion slope.

Further features of the present invention will become apparent from the following description of exemplary embodiments with reference to the attached drawings.

### BRIEF DESCRIPTION OF THE DRAWINGS

FIG. 1 is a diagram describing the configuration of an optical transmission apparatus according to a first embodiment.

FIG. 2 is a diagram illustrating the change in a temporal waveform when compensation for a dispersion slope is not performed.

FIG. 3A is a diagram describing the dispersion characteristics of a transmission apparatus according to the first embodiment.

FIG. 3B is a diagram describing the total amount of dispersions of a negative dispersion medium and a second fiber in a transmission apparatus according to the first embodiment.

FIG. 4A is a diagram describing the change in an intensity spectrum due to a nonlinear optical effect in a case where the length of a first fiber is 1 mm.

FIG. 4B is a diagram describing the change in an intensity spectrum due to a nonlinear optical effect in a case where the length of the first fiber is 5 mm.

FIG. 4C is a diagram describing the change in an intensity spectrum due to a nonlinear optical effect in a case where the length of the first fiber is 10 mm.

FIG. 5A is a diagram illustrating the spectrum of a laser pulse that has propagated through the first fiber with a length of 100 mm after the thickness of a negative dispersion medium was set to 2 mm.

FIG. 5B is a diagram illustrating the spectrum of a laser pulse that has propagated through the first fiber with a length of 100 mm after the thickness of a negative dispersion medium was set to 3 mm.

FIG. 5C is a diagram illustrating the spectrum of a laser pulse that has propagated through the first fiber with a length of 100 mm after the thickness of a negative dispersion medium was set to 5 mm.

FIG. 5D is a diagram illustrating the spectrum of a laser pulse that has propagated through the first fiber with a length of 100 mm after the thickness of a negative dispersion medium was set to 10 mm.

FIG. 6A is a diagram illustrating the dispersion characteristics of a negative dispersion medium in a transmission apparatus according to the first embodiment.

FIG. 6B is a diagram illustrating the dispersion characteristics of the first fiber in a transmission apparatus according to the first embodiment.

FIG. 6C is a diagram illustrating the dispersion characteristics of the second fiber in a transmission apparatus according to the first embodiment.

FIG. 6D is a diagram illustrating the total amount of dispersions in a transmission apparatus according to the first embodiment.

FIG. 7A is a diagram illustrating the calculated temporal waveform of light output from a transmission apparatus according to the first embodiment.

FIG. 7B is a diagram illustrating the calculated intensity spectrum of light output from a transmission apparatus according to the first embodiment.

FIG. 8 is a diagram describing the configuration of a transmission apparatus according to a second embodiment.

FIG. 9A is a diagram describing the configuration of a transmission apparatus according to a third embodiment.

FIG. 9B is a diagram describing the configuration of a nonlinear optical element according to the third embodiment.

FIG. 10 is a diagram illustrating the dispersion characteristics of a transmission apparatus according to the third embodiment.

FIG. 11 is a diagram describing the configuration of an information acquisition apparatus according to a fourth embodiment.

FIG. 12 is a diagram describing the configuration of an information acquisition apparatus according to a fifth embodiment.

### DESCRIPTION OF THE EMBODIMENTS

In the transmission of short pulse light through an optical fiber, the use of a dispersion compensator such as a diffraction grating sometimes reduces the intensity of short pulse light. This leads to a decrease in transmission efficiency. The diffraction grating disclosed in U.S. Pat. No. 6,249,630 has a positive dispersion slope like the optical fiber. Therefore, the diffraction grating can perform dispersion compensation at a specific wavelength, but cannot perform sufficient compensation in consideration of the dispersion slope. Broadband dispersion compensation may not be performed. As disclosed in U.S. Patent Application Publication No. 2012/0134011, the shaping of a pulse waveform of short pulse light using a nonlinear optical effect depends on light intensity. The unstable output of short pulse light from a light source therefore leads to an unstable pulse waveform.

In the following embodiments, a transmission apparatus that efficiently transmits short pulse light using an optical fiber while reducing dispersion of the optical fiber and the influence of a nonlinear optical effect will be described.

### First Embodiment

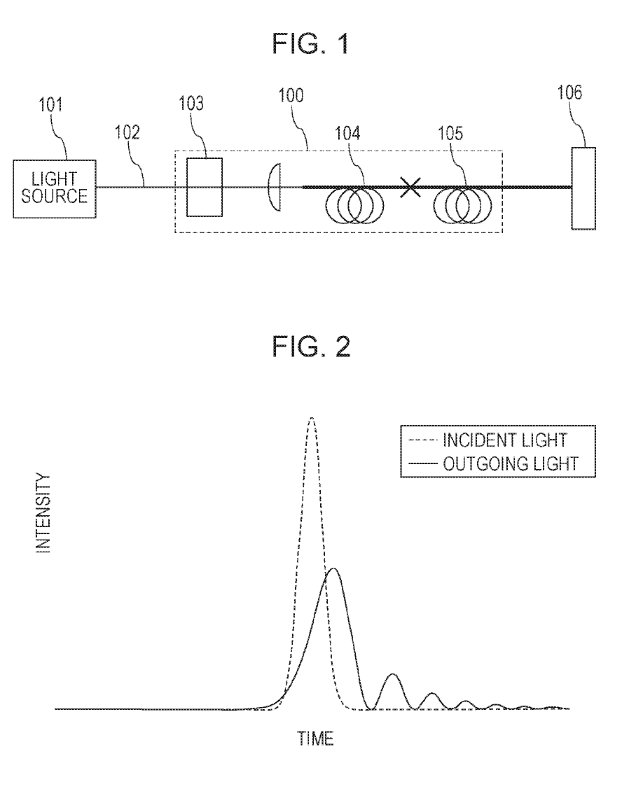

An optical transmission apparatus 100 according to this embodiment will be described with reference to FIG. 1. FIG. 1 is a block diagram describing the configuration of the transmission apparatus 100. The transmission apparatus 100 includes a negative dispersion medium 103 (hereinafter referred to as “dispersion medium” or “medium 103”), a first fiber 104, and a second fiber 105. The second fiber 105 is connected to a photoconductive element 106. Short pulse light 102 (hereinafter referred to as a “laser pulse 102”) output from a light source 101 enters the photoconductive element 106 after transmitting through the transmission apparatus 100. The short pulse light is pulsed light whose pulse width is in the order of femtoseconds (fs). In this embodiment, as the laser pulse 102, a short pulse light whose pulse width is equal to or less than 100 femtoseconds (100 fs) is used.

The light source 101 generates the laser pulse 102 in a known manner. In one embodiment, as the light source 101, a fiber laser for outputting the laser pulse 102 with a center wavelength of 1.55 μm (1550 nm), a repetition frequency of 80 MHz, and a peak power of 40 kW is used. The temporal waveform of the laser pulse 102 is close to a Fourier transform limited Gaussian waveform with the pulse width of 30 fs. At a position on a propagation path of the laser pulse 102 and near the light source 101, an isolator, a quarter wavelength plate, or a polarization beam splitter may be disposed to prevent the laser pulse 102 from being destabilized by returned light reflected from another member. Instead of the fiber laser as the light source 101, a known light source such as a solid-state laser can be used on condition that it can generate the laser pulse 102 with the above-described wavelength band and the above-described pulse width.

The laser pulse 102 enters the medium 103. The medium 103 has a negative dispersion parameter in a part of or the whole of the wavelength band of the laser pulse 102. The medium 103 is a bulk medium having a positive dispersion slope in a part of or the whole of the wavelength band of the laser pulse 102. It is desired that the medium 103 have a negative dispersion parameter and a positive dispersion slope in the whole of the wavelength band of the laser pulse 102.

In this embodiment, as the medium 103, a silicon (Si) plate is used. The medium 103 is made of silicon, but may be made of zinc selenide, zinc sulfide, KRS-5 (a mixed crystal of tantalum bromide and tantalum iodide), potassium bromide, or sodium chloride. It is desired that an antireflection film be formed on the surface of the medium 103 to prevent the laser pulse 102 from suffering from a Fresnel loss at an interface between silicon and air. Alternatively, in order to minimize a Fresnel loss, the medium 103 may be disposed so that the laser pulse 102 is s-polarized light with respect to the medium 103 and an angle of incidence of the laser pulse 102 is the Brewster's angle.

The laser pulse 102 that has passed through the medium 103 enters the first fiber 104. The first fiber 104 is a negative dispersion fiber having a negative dispersion parameter in a part of or the whole of the wavelength band of the laser pulse 102. In the following description, the first fiber 104 is called a “negative dispersion fiber 104”. The negative dispersion fiber 104 is an optical fiber having a negative dispersion slope in a part of or the whole of the wavelength band of the laser pulse 102. It is desired that the negative dispersion fiber 104 have a negative dispersion parameter and a negative dispersion slope in the whole of the wavelength band of the laser pulse 102. It is noted that instead of positive and negative dispersion, the terms normal and anomalous dispersion can be used. Normal dispersion implies that the group velocity decreases for increasing optical frequency; and vice versa for anomalous dispersion.

Typical optical fibers have positive material dispersion, and small waveguide dispersion, and therefore have a positive dispersion parameter and a positive dispersion slope like quartz. However, by reducing the diameter of a core portion (core diameter) to increase waveguide dispersion, a negative dispersion fiber having negative dispersion can be produced. A negative dispersion fiber can be used as a dispersion compensator for a typical optical fiber (a positive dispersion fiber having a positive dispersion parameter).

A “dispersion parameter” is an indicator of the dependence of a group velocity on a wavelength, and is attributable to the fact that the index of refraction of a material depends on a wavelength. For example, in a medium having a positive dispersion parameter, the longer the wavelength, the lower the group velocity. A “dispersion slope” is a wavelength differentiation value of a dispersion parameter. In this specification, a fiber having a positive dispersion parameter is called a positive dispersion fiber and a fiber having negative dispersion parameter is called a negative dispersion fiber.

The negative dispersion fiber 104 has a core diameter smaller than that of a positive dispersion fiber and a small Mode Field Area (MFA). The typical MFA of a positive dispersion fiber is approximately 100 μm², and the typical MFA of a negative dispersion fiber is 10 μm² or less. The MFA of a positive dispersion fiber is several tens of times larger than that of a negative dispersion fiber. The light density of the negative dispersion fiber 104 is therefore high. Light propagating through the negative dispersion fiber 104 is thus susceptible to a nonlinear optical effect. That is, for the efficient transmission of the laser pulse 102, it is more important to suppress a nonlinear optical effect in the negative dispersion fiber 104 than to suppress a nonlinear optical effect in the second fiber (positive dispersion fiber) 105. In order to increase the pulse width of the laser pulse 102 and reduce the peak power of the laser pulse 102, the laser pulse 102 output from the light source 101 is input into the negative dispersion fiber 104 via the medium 103.

In this embodiment, as the negative dispersion fiber 104, a photonic crystal fiber having, with respect to the wavelength of 1.55 μm, the dispersion parameter of −75 ps/nm/km, the dispersion slope of −0.75 ps/nm²/km, the mode field diameter of 3 μm, and the nonlinear constant of 0.0429 (/m/W) is used. As a material, silicon dioxide (SiO₂) is used. As the negative dispersion fiber 104, a step index optical fiber or a photonic crystal fiber having negative dispersion and a negative dispersion slope may be used.

As described previously, light propagating through the negative dispersion fiber 104 is susceptible to a nonlinear optical effect. The thickness of the medium 103 in the direction of an optical axis of the laser pulse 102 propagating through the medium 103 needs to be large enough to sufficiently reduce the peak power of the laser pulse 102 passing through the medium 103. In this embodiment, the thickness of the medium 103 is set to 10 mm.

The second fiber 105 is a positive dispersion fiber having a positive dispersion parameter in a part of or the whole of the wavelength band of the laser pulse 102. The second fiber 105 is a single-mode fiber having a positive dispersion slope in a part of or the whole of the wavelength band of the laser pulse 102. In the following description, the second fiber 105 is called a “positive dispersion fiber 105”. It is desired that the positive dispersion fiber 105 have a positive dispersion parameter and a positive dispersion slope in the whole of the wavelength band of the laser pulse 102. As the positive dispersion fiber 105, a quartz fiber or a photonic crystal fiber can be used. The laser pulse 102 that has passed through the negative dispersion fiber 104 enters the positive dispersion fiber 105. In order to enhance robustness, it is desired that the negative dispersion fiber 104 and the positive dispersion fiber 105 be connected by fusion splicing.

In this embodiment, as the positive dispersion fiber 105, Corning® SMF-28® that is a single-mode fiber is used. That is, the positive dispersion fiber 105 is an optical fiber having, with respect to the wavelength of 1.55 μm, the dispersion parameter of 17.41 ps/nm/km, the dispersion slope of 0.0584 ps/nm²/km, the mode field diameter of 10 μm, and the nonlinear constant of 0.00143 (/m/W). It is desired that a polarization maintaining fiber be used as the negative dispersion fiber 104 and the positive dispersion fiber 105.

Since the negative dispersion fiber 104 has a negative dispersion parameter, the pulse width of the laser pulse 102 increases and the peak power of the laser pulse 102 decreases as the laser pulse 102 that has entered the negative dispersion fiber 104 propagates through the negative dispersion fiber 104. That is, in a case where the peak power of the laser pulse 102 is sufficiently small at a laser incidence position in the negative dispersion fiber 104, the peak power is sufficiently small in any position in the negative dispersion fiber 104. Subsequently, the laser pulse 102 enters the positive dispersion fiber 105. At an output end of the positive dispersion fiber 105, dispersion compensation is performed and the peak power of the laser pulse 102 is increased.

It is desired that dispersion compensation be achieved for the laser pulse 102 output from the positive dispersion fiber 105 in the frequency range of the laser pulse 102. The lengths of the medium 103, the negative dispersion fiber 104, and the positive dispersion fiber 105 are set so that the sum of group velocity dispersions of the medium 103, the negative dispersion fiber 104, and the positive dispersion fiber 105 and the sum of dispersion slopes of the medium 103, the negative dispersion fiber 104, and the positive dispersion fiber 105 become close to zero. In this embodiment, the length of the medium 103 is set to 10 mm, the length of the negative dispersion fiber 104 is set to 100 mm, and the length of the positive dispersion fiber 105 is set to 950 mm. The length of each component will be described later.

The laser pulse 102 output from the positive dispersion fiber 105 is directed at the photoconductive element 106. The photoconductive element 106 is an optical element for generating or detecting a terahertz wave and is made of, for example, low-temperature-grown GaAs or InGaAs. A portion of the photoconductive element 106 at which the laser pulse 102 is directed may be coated with an antireflection film.

In order to direct the laser pulse 102 output from the positive dispersion fiber 105 at the photoconductive element 106, SELFOC® lenses or ball lenses may be integrated at the end of the positive dispersion fiber 105 on the side of the photoconductive element 106. The positive dispersion fiber 105 may be a pigtail fiber obtained by processing the end of the positive dispersion fiber 105 on the side of the photoconductive element 106 or a lensed fiber. The positive dispersion fiber 105 and the photoconductive element 106 may be connected using a direct coupling (butt coupling) method on the condition that the mode field diameter of the positive dispersion fiber 105 and a laser beam diameter needed by the photoconductive element 106 are substantially the same.

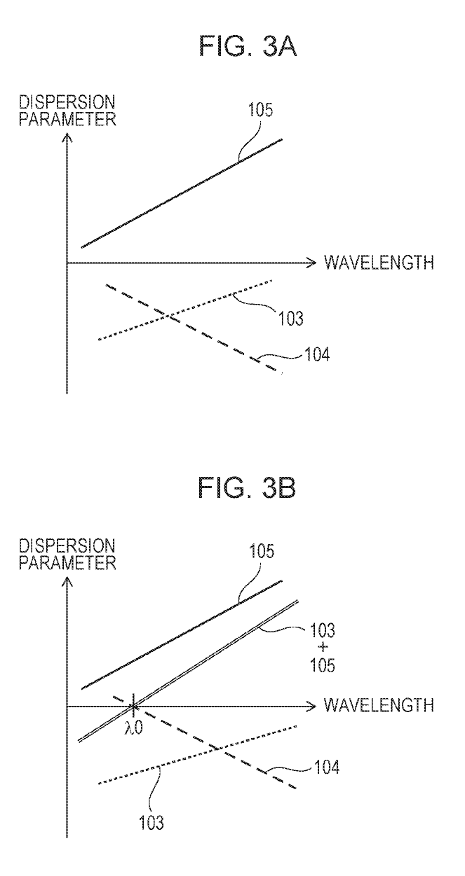

The lengths of the medium 103, the negative dispersion fiber 104, and the positive dispersion fiber 105 in the direction of an optical axis of the laser pulse 102 will be described. The dispersion characteristics of the medium 103, the negative dispersion fiber 104, and the positive dispersion fiber 105 are illustrated in FIG. 3A. The dispersion parameters and dispersion slopes of the medium 103, the negative dispersion fiber 104, and the positive dispersion fiber 105 are indicated by table 1. The laser pulse 102 is in a longer-wavelength region than a zero dispersion wavelength of the positive dispersion fiber 105.

TABLE 1

| | Dispersion | Dispersion |
|---|---|---|
| | Parameter | Slope |
| Negative Dispersion Medium | Negative | Positive |
| Negative Dispersion Fiber (First Fiber) | Negative | Negative |
| Positive Dispersion Fiber (Second Fiber) | Positive | Positive |

In a case where the laser pulse 102 propagates through a certain material, the magnitude of dispersion given to the laser pulse 102 by the material can be expressed with a dispersion parameter and a dispersion slope. A dispersion parameter D is expressed by Expression (5) and a dispersion slope S is expressed by Expression (6). In these expressions, ?represents the wavelength of the laser pulse 102, c represents a light speed, and n represents the index of refraction of a material at the wavelength of the laser pulse 102.

$$\begin{matrix}D ( λ ) = - \frac{λ}{c} \frac{{d}^{2} n}{d {λ}^{2}} & ( 5 ) \\ S ( λ ) = \frac{d D ( λ )}{d λ} & ( 6 )\end{matrix}$$

The index of refraction n in Expression (5) can be calculated using the Sellmeier's equation (Expression (7)) representing the dependence of the index of refraction on a wavelength (C. D. Salzberg and J. J. Villa, Journal of Optical Society of America, Vol. 47, p. 244, (1957)).

$${n}^{2} - 1 = \frac{10.6684293 {λ}^{2}}{{λ}^{2} - {0.301516485}^{ 2}} + \frac{0.003043475 {λ}^{2}}{{λ}^{2} - {1.13475115}^{ 2}} + \frac{1.54133408 {λ}^{2}}{{λ}^{2} - {1104.0}^{ 2}} \qquad ( 7 )$$

Using Expressions (5) to (7), the dispersion parameter D and the dispersion slope S can be obtained. For example, in a case where the wavelength λ is 1550 nm, silicon that is the medium 103 has the dispersion parameter D of −879.6 ps/nm/km and the dispersion slope S of 1.983 ps/nm²/km, that is, has a negative dispersion parameter and a positive dispersion slope in the wavelength band of 1550 nm.

As described previously, the MFA of the negative dispersion fiber 104 is small. Accordingly, the pulse waveform of the laser pulse 102 that propagates through the negative dispersion fiber 104 may be changed under the influence of a nonlinear optical effect. Thus, as a result of the use of the negative dispersion fiber 104 for the purpose of compensation for dispersion of the positive dispersion fiber 105, the pulse waveform of the laser pulse 102 is changed under the influence of a nonlinear optical effect. This leads to the changes in the temporal waveform and spectrum shape of the laser pulse 102. In the transmission apparatus 100, in order to reduce the influence of a nonlinear optical effect in the negative dispersion fiber 104, the laser pulse 102 is input into the medium 103 to increase the pulse width of the laser pulse 102 and reduce the peak power of the laser pulse 102.

In a case where the laser pulse 102 close to a Fourier transform limit propagates through a certain material, a propagation length L_{NL} at which the influence of a nonlinear optical effect of the material on the temporal waveform and spectrum shape of the laser pulse 102 starts to become evident is expressed by Expression (8) where γ represents the nonlinear optical constant of the material through which the laser pulse 102 propagates and P represents the peak power of the laser pulse 102 when the laser pulse 102 enters the material.

$${L}_{NL} = \frac{1}{γ P} \qquad ( 8 )$$

A propagation length L_{D} required for the increase in the pulse width of the laser pulse 102 due to dispersion is expressed by Expression (9) where T₀ represents the pulse width of the laser pulse 102 before the laser pulse 102 enters the material and GVD represents the group velocity dispersion of the material through which the laser pulse 102 propagates.

$${L}_{D} = \frac{{T}_{0}^{2}}{\vert GVD \vert} \qquad ( 9 )$$

The group velocity dispersion GVD is expressed by Expression (10) using a dispersion parameter D of the material.

$$GVD = - \frac{{λ}^{2}}{2 π c} D \qquad ( 10 )$$

In a case where the following expressions (11) and (12) are satisfied in which L represents a propagation length of a certain material through which the laser pulse 102 propagates, the influence of a nonlinear optical effect on pulse light cannot be ignored.

L_{NL}<L (11)

L_{NL}<L_{D} (12)

In this embodiment, the pulse width of the laser pulse 102 is 30 fs, the peak power of the laser pulse 102 is 40 kW, and the center wavelength of the laser pulse 102 is 1.55 μm. In a case where the dispersion parameter of the negative dispersion fiber 104 is −75 ps/nm/km (96 fs²/mm in terms of a group velocity dispersion) and a nonlinear optical constant 0.0429 (/m/W), L_{D} is 4.7 mm and L_{NL} is 1.1 mm. Accordingly, for example, in a case where the laser pulse 102 propagates through the negative dispersion fiber 104 with the length of 10 mm, Expressions (11) and (12) are satisfied at the same time and the influence of a nonlinear optical effect appears.

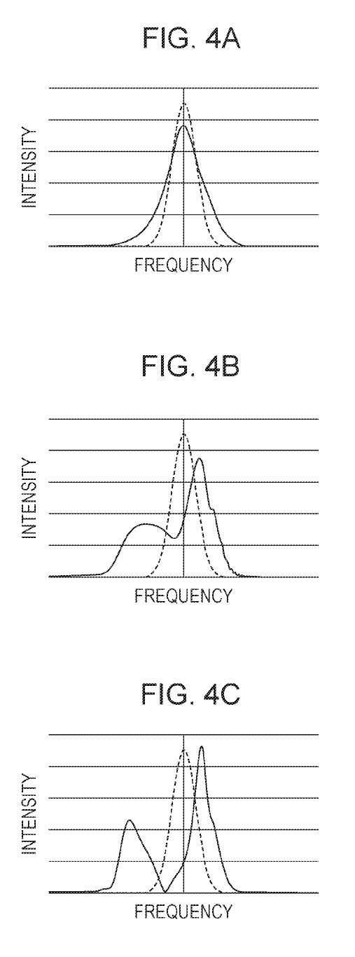

FIG. 4A is a diagram illustrating the change in the spectrum of the laser pulse 102 in a case where the laser pulse 102 propagates through the negative dispersion fiber 104 with the length of 1 mm. FIG. 4B is a diagram illustrating the change in the spectrum of the laser pulse 102 in a case where the laser pulse 102 propagates through the negative dispersion fiber 104 with the length of 5 mm. FIG. 4C is a diagram illustrating the change in the spectrum of the laser pulse 102 in a case where the laser pulse 102 propagates through the negative dispersion fiber 104 with the length of 10 mm. In FIGS. 4A to 4C, a straight line represents the spectrum of the laser pulse 102 after the laser pulse 102 has propagated through the negative dispersion fiber 104 and a dotted line represents the spectrum of the laser pulse 102 output from the light source 101.

As described previously, a nonlinear optical effect is large in the negative dispersion fiber 104. A method of reducing the influence of the nonlinear optical effect of the negative dispersion fiber 104 on the laser pulse 102 will be therefore considered. In order to reduce the influence of the nonlinear optical effect of the negative dispersion fiber 104 on the laser pulse 102, the laser pulse 102 is input into the negative dispersion fiber 104 via the medium 103 satisfying the following Expressions (1) to (4) where L₁ represents the length of the medium 103 in the direction of an optical axis of the laser pulse 102, T₀ represents the pulse width of the laser pulse 102 immediately before the laser pulse 102 enters the medium 103, b₂ represents the group velocity dispersion of the negative dispersion fiber 104 per unit length (1 mm), P₃ represents the peak power of the laser pulse 102 immediately before the laser pulse 102 passes through the medium 103, P_{L} represents the peak power of the laser pulse 102 immediately after the laser pulse 102 has passed through the medium 103, and b_{nd} represents the group velocity dispersion of the medium 103 per unit length.

$$\begin{matrix}{L}_{D} < {L}_{NL} & ( 1 ) \\ {L}_{D} = \frac{{T}_{0}^{2}}{{b}_{2}} & ( 2 ) \\ \begin{matrix}{L}_{NL} = \frac{1}{γ {P}_{1}} \\ = \frac{1}{γ {P}_{0}} \sqrt{1 + {( {CL}_{1} )}^{2}}\end{matrix} & ( 3 ) \\ C = \frac{4 ln 2 {b}_{nd}}{{T}_{0}^{2}} & ( 4 )\end{matrix}$$

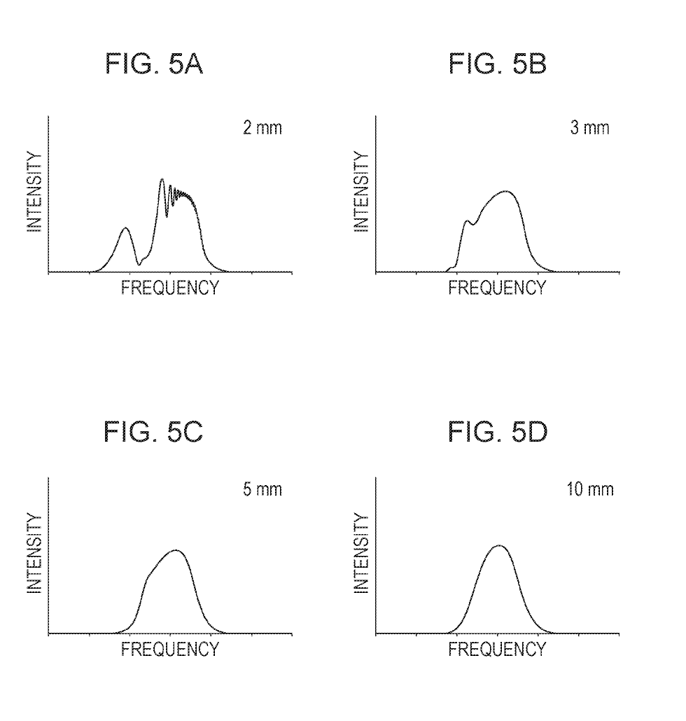

Calculation results of the spectrum of the laser pulse 102 that has propagated through the negative dispersion fiber 104 with the length of 100 mm after passing through the medium 103 are illustrated in FIGS. 5A to 5D. Spectrums calculated when the thickness of the medium 103 is 2 mm, 3 mm, 5 mm, and 10 mm are illustrated in FIGS. 5A to 5D, respectively. As the medium 103 gets thicker, the peak power of the laser pulse 102 to enter the negative dispersion fiber 104 decreases, L_{NL} increases, and the value of L_{D}/L_{NL} decreases. The values of the L_{D}/L_{NL} obtained when the thickness of the medium 103 is 2 mm, 3 mm, 5 mm, and 10 mm are 2.3, 1.6, 0.93, and 0.46, respectively.

In a case where L_{D}<L_{NL} is satisfied, that is, the thickness of the medium 103 is 5 mm and 10 mm, a spectrum shape shows little change as illustrated in FIGS. 5C and 5D. On the other hand, in a case where L_{D}>L_{N}, is satisfied, that is, the thickness of the medium 103 is 2 mm and 3 mm, a spectrum shape shows a change as illustrated in FIGS. 5A and 5B. This change arises from the nonlinear optical effect of the negative dispersion fiber 104, and causes the loss of the temporal waveform and spectrum shape of the laser pulse 102.

Subsequently, the length of the positive dispersion fiber 105 will be described. The medium 103 and the positive dispersion fiber 105 have positive dispersion slopes, and the negative dispersion fiber 104 has a negative dispersion slope. By appropriately setting the lengths of the medium 103, the negative dispersion fiber 104, and the positive dispersion fiber 105, compensation for a dispersion parameter and compensation for a dispersion slope can be made at the same time.

A length L₁ of the medium 103, a length L₂ of the negative dispersion fiber 104, and a length L₃ of the positive dispersion fiber 105 can be calculated with their dispersions (D₁, D₂, and D₃) and their dispersion slopes (S₁, S₂, and S₃). That is, by solving simultaneous linear equations (13) and (14), the ratio of L₁, L₂, and L₃ can be uniquely determined.

D₁L₁+D₂L₂+D₃L₃=0 (13)

S₁L₁+S₂L₂+S₃L₃=0 (14)

Since there is higher-order dispersion in reality, it is difficult to perform design so that the sum of dispersions becomes zero in the whole of the wavelength band using Expressions (13) and (14). Accordingly, it is desired that the length L₁, L₂, and L₃ be finely adjusted so that the total amount of dispersions of the medium 103, the negative dispersion fiber 104, and the positive dispersion fiber 105 becomes sufficiently small in the frequency range (spectral region) of the laser pulse 102.

In this specification, the phrase “the total amount of dispersions is sufficiently small” means that the total amount of dispersions b₂ₐₗₗ of the medium 103, the negative dispersion fiber 104, and the positive dispersion fiber 105 is smaller than the pulse width T₀ in the spectral region of the laser pulse 102. This relationship is expressed by Expression (15). The total amount of dispersions is the sum of dispersions of the medium 103, the negative dispersion fiber 104, and the positive dispersion fiber 105, and is expressed by the left side of Expression (13).

|b₂ₐₗₗ|<T₀² (15)

The dispersion characteristics of the medium 103 and the dispersion characteristics of the positive dispersion fiber 105 are determined in accordance with the dispersion characteristics of a material used. On the other hand, the dispersion characteristics of the negative dispersion fiber 104 can be changed in accordance with a cross-section structure design. In order to describe dispersion characteristics that should be possessed by the negative dispersion fiber 104, the total amount of dispersions of the medium 103 and the positive dispersion fiber 105 is illustrated in FIG. 3B. A wavelength λ₀ at which the total amount of dispersions of the medium 103 and the positive dispersion fiber 105 becomes zero is a longer wavelength than a zero dispersion wavelength of the positive dispersion fiber 105. For example, in a case where the center wavelength of the laser pulse 102 is 1550 nm, the laser pulse 102 is pulsed light having the wavelength band of 1450 nm to 1650 nm. At that time, the zero dispersion wavelength of the negative dispersion fiber 104 is approximately 1450 nm, and the zero dispersion wavelength of the positive dispersion fiber 105 is in the range of approximately 1300 nm to 1350 nm.

The amount of wavelength shift from the zero dispersion wavelength of the positive dispersion fiber 105 to the wavelength λ₀ is changed in accordance with the amount of dispersion of the medium 103.

The dispersion characteristics that should be possessed by the negative dispersion fiber 104 may be opposite in sign to the total amount of dispersions of the medium 103 and the positive dispersion fiber 105. That is, in a case where the dispersion characteristics of the medium 103 and the dispersion characteristics and length of the positive dispersion fiber 105 are determined, the negative dispersion fiber 104 may be set so that it has the zero dispersion wavelength λ₀ and the negative dispersion slope. The zero dispersion wavelength λ₀ can be adjusted by changing the core diameter and fiber cross-sectional shape of the negative dispersion fiber 104. A dispersion slope amount can be adjusted by changing the length of the negative dispersion fiber 104. Fine adjustment is sometimes needed in consideration of higher-order dispersion. However, in a case where higher-order dispersion is comparatively small, the dispersion characteristics and length of each component can be obtained as described previously.

The laser pulse 102 that has passed through the positive dispersion fiber 105 may have a plurality of peaks because of higher-order dispersion. In a case where the laser pulse 102 has a plurality of peaks of substantially the same size, the optimization of a pulse width is not achieved. It is therefore desired that the power of a main peak of the laser pulse 102 account for 70% or more of the whole power of the laser pulse 102. It is further desired that the power of a main peak of the laser pulse 102 that has passed through the transmission apparatus 100 account for 70% or more of the peak power of the laser pulse 102 immediately after the laser pulse 102 has output from the light source 101.

In this embodiment, the thickness of the medium 103 is set to 10 mm. In this case, the pulse width of the laser pulse 102 output from the light source 101 is 30 fs and the pulse width of the laser pulse 102 output from the medium 103 is 813 fs. In this case, the propagation length L_{D} calculated using Expression (2) is 9.42 mm and the propagation length L_{NL} calculated using Expression (3) is 15.7 mm, so that Expression (1) is satisfied. As a result, the transmission apparatus 100 according to this embodiment can reduce the influence of the nonlinear optical effect and dispersion of the optical fiber and efficiently transmit the laser pulse 102.

In a case where the lengths of the medium 103, the negative dispersion fiber 104, and the positive dispersion fiber 105 are finely adjusted, it is desired that the lengths be set so as not to affect the pulse width of the laser pulse 102. More specifically, it is desired that the degree of adjustment accuracy ΔL_{fiber} required for the adjustment of the length of the positive dispersion fiber 105 satisfy Expression (16) where T₀ represents the pulse width of the laser pulse 102 output form the light source 101 and b_{2fiber} represents the amount of group velocity dispersion per unit length of the positive dispersion fiber 105.

|b_{2fiber}·ΔL_{fiber}|<T₀² (16)

Since the amount of group velocity dispersion b_{2fiber} is −22.1 fs²/mm and the pulse width T₀ is 30 fs, ΔL_{fiber}<40 mm is obtained from Expression (16). In this embodiment, in order to more precisely obtain an optimum value, the combination of lengths with which the total amount of dispersions becomes the minimum value is searched for while changing a fiber length in 10 mm increments. The degree of adjustment accuracy needed to adjust the length of each of the medium 103 and the negative dispersion fiber 104 can be similarly calculated. At the time of construction of an optical system, the optimization of the lengths of the negative dispersion fiber 104 and the positive dispersion fiber 105 using a cutback method is needed because of individual differences between the negative dispersion fiber 104 and the positive dispersion fiber 105. The degree of accuracy needed to optimize the lengths of the negative dispersion fiber 104 and the positive dispersion fiber 105 is the same as that calculated with Expression (16). The “cutback method” is a method of investigating characteristics while cutting a fiber little by little to obtain an optimal fiber length.

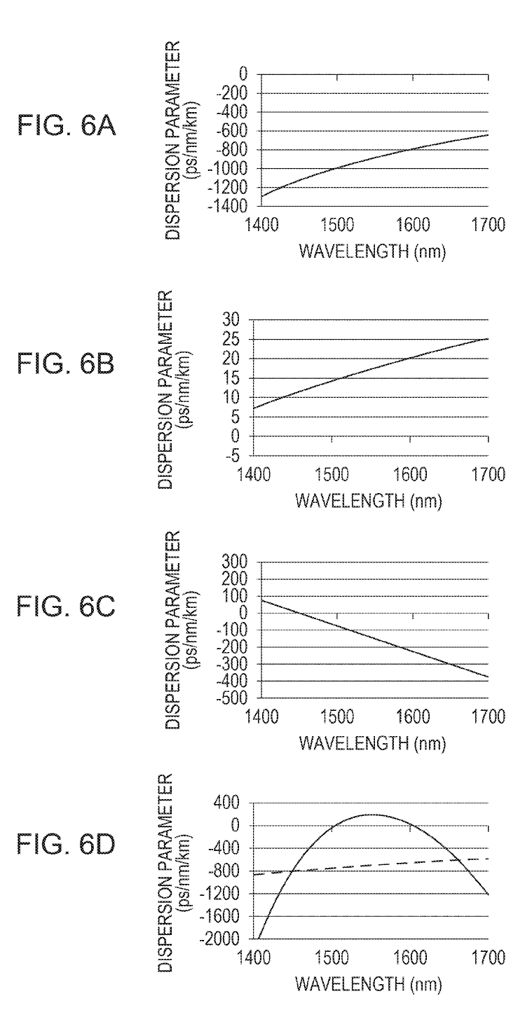

The dispersion characteristics of the transmission apparatus 100 obtained when the lengths of the medium 103, the negative dispersion fiber 104, and the positive dispersion fiber 105 are set as above will be described. The dispersion characteristics of the medium 103, the negative dispersion fiber 104, and the positive dispersion fiber 105 are illustrated in FIGS. 6A, 6B, and 6C, respectively. The total amount of dispersions in the transmission apparatus 100 in which the lengths of the medium 103, the negative dispersion fiber 104, and the positive dispersion fiber 105 are set as above is illustrated in FIG. 6D. In FIG. 6D, a broken line indicates the group velocity dispersion T₀²=−900 fs² calculated with Expression (7). As is apparent from these drawings, in the range of 1450 nm to 1650 nm that is the wavelength band of the laser pulse 102, Expression (15) is satisfied and dispersion compensation is successfully performed.

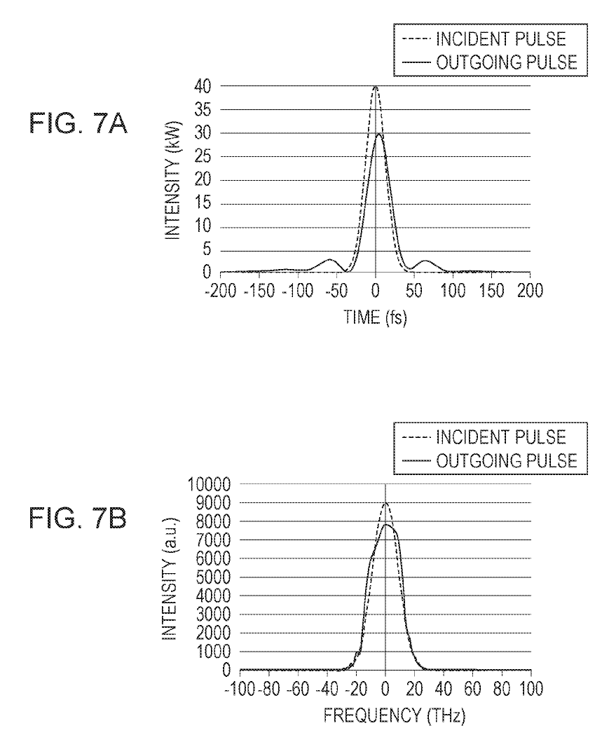

A calculation result of the temporal waveform of the laser pulse 102 that has passed through the medium 103, the negative dispersion fiber 104, and the positive dispersion fiber 105 is illustrated in FIG. 7A. FIG. 7B is a graph indicating an intensity spectrum obtained by performing a Fourier transform upon the temporal waveform illustrated in FIG. 7A in which a horizontal axis represents frequency. In FIGS. 7A and 7B, dotted lines represent the laser pulse 102 (incident light) that has yet to enter the medium 103 and solid lines represent the laser pulse 102 (outgoing light) output from the positive dispersion fiber 105.

For the calculation of the temporal waveform, a value calculation method called a split-step Fourier method (see Govind P. Agrawal, Nonlinear Fiber Optics third Edition, Academic Pres) is used. As a differential equation describing the time evolution of the laser pulse 102 (the change in the physical quantity of the laser pulse 102 over time), the following expressions (17) to (19) are used. In these expressions, λ represents the wavelength of the laser pulse 102, A(z, t) represents the envelope of an electric field of the laser pulse 102, β₂ represents the secondary group velocity dispersion of a material through which the laser pulse 102 propagates, β₃ represents the third-order group velocity dispersion of a material through which the laser pulse 102 propagates, γ represents a nonlinear coefficient of a material through which the laser pulse 102 propagates, and D represents a dispersion parameter for a material through which the laser pulse 102 propagates.

$$\begin{matrix}\frac{\partial A}{\partial z} + \frac{α}{2} A + \frac{{iβ}_{2}}{2} \frac{{\partial }^{2} A}{\partial {T}^{2}} - \frac{{β}_{3}}{6} \frac{{\partial }^{3} A}{\partial {T}^{3}} = i γ {\vert A \vert}^{2} A & ( 17 ) \\ {β}_{2} = - \frac{{λ}^{2}}{2 {nc}^{2}} D & ( 18 ) \\ {β}_{3} = - \frac{d {β}_{2}}{d ω} & ( 19 )\end{matrix}$$

In both of FIGS. 7A and 7B, the significant distortions of the temporal waveform and spectrum shape of the laser pulse 102 do not appear because the peak power of the laser pulse 102 is reduced after the laser pulse 102 has passed through the medium 103. The shape of the temporal waveform is substantially the same as that of incident light because compensation for a dispersion parameter and a dispersion slope is performed by adjusting the lengths of the medium 103, the negative dispersion fiber 104, and the positive dispersion fiber 105. The temporal waveform illustrated in FIG. 7A has two small side peaks in addition to a main peak. The power of the main peak accounts for 82% of the whole power of the incident light. The outgoing light therefore can be used as light to be input into the photoconductive element 106.

The configuration of the transmission apparatus 100 has been described. Using the transmission apparatus 100 according to this embodiment, it is possible to reduce the influence of a nonlinear optical effect to the extent that the reduction does not affect the pulse waveform of the laser pulse 102 by entering the laser pulse 102 into the negative dispersion fiber 104 via the medium 103.

Furthermore, by setting the length of the medium 103, the negative dispersion fiber 104, and the positive dispersion fiber 105 as described previously, compensation for a dispersion parameter and a dispersion slope can be performed. As a result, the transmission apparatus 100 can reduce dispersion of an optical fiber and the influence of a nonlinear optical effect and efficiently transmit short pulse light.

### Second Embodiment

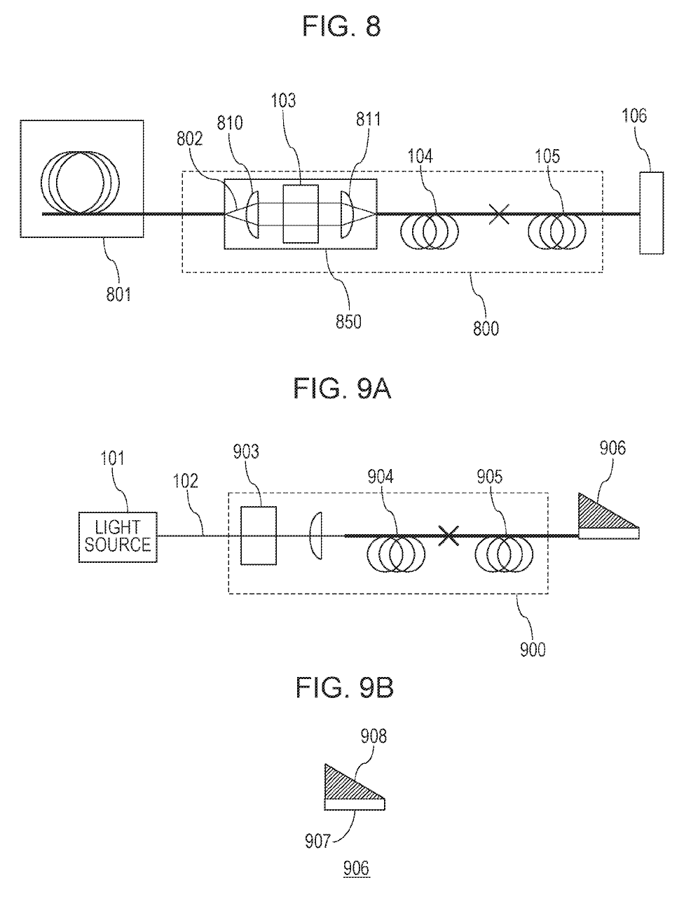

A transmission apparatus 800 according to this embodiment will be described with reference to FIG. 8. FIG. is a diagram describing the configuration of the transmission apparatus 800. In this embodiment, as the light source 101, a fiber laser 801 is used. On a propagation path of a laser pulse 802 output from the fiber laser 801, an optical unit including a collimating lens 810 and a condenser lens 811 is disposed. The other part is the same as that according to the first embodiment, and the description thereof will be therefore omitted.

The collimating lens 810, the medium 103, and the condenser lens 811 are fixedly disposed in a single casing 850 and integrated. An output fiber end of the fiber laser 801 is connected to the casing 850. The laser pulse 802 output from the fiber laser 801 is converted into parallel light by the collimating lens 810 and passes through a silicon plate that is the medium 103. The casing 850 is connected to the negative dispersion fiber 104. The laser pulse 802 that has passed through the medium 103 is collected by the condenser lens 811 and enters the core of the negative dispersion fiber 104.

By mechanically integrating the collimating lens 810, the medium 103, and the condenser lens 811, the coupling efficiency of the laser pulse 802 to enter the negative dispersion fiber 104 can be increased and can be stabilized for a long time.

It is desired that the collimating lens 810 have a structure used to adjust the position thereof relative to the negative dispersion fiber 104 in a planar direction perpendicular to the optical axis of the laser pulse 802 that propagates through the collimating lens 810. It is also desired that the condenser lens 811 have a structure used to adjust the position thereof relative to the negative dispersion fiber 104. These relative position adjustment structures can optimize the efficiency of coupling between the laser pulse 802 and the negative dispersion fiber 104.

In a case where the medium 103, the negative dispersion fiber 104, and the positive dispersion fiber 105 have the same lengths described in the first embodiment, the medium 103 may be silicon with the thickness of 10 mm and the distance between the collimating lens 810 and the condenser lens 811 may be 10 mm or longer. The absolute value of silicon of the medium 103 is several tens of times larger than that of the dispersion parameter of a typical positive dispersion fiber. Therefore, as compared with the lengths of the negative dispersion fiber 104 and the positive dispersion fiber 105, a more compact free space portion can be designed.

The laser pulse 802 output from the fiber laser 801 may be chirped pulse light. For example, if the fiber laser 801 can realize chirping identical to dispersion given by the medium 103, the medium 103 becomes unnecessary. In this case, by directly connecting the outgoing end of the fiber laser 801 and the negative dispersion fiber 104 by fusion splicing, a transmission apparatus for transmitting pulse light can be realized.

Thus, the transmission apparatus 800 according to this embodiment can reduce dispersion of an optical fiber and the influence of a nonlinear optical effect and efficiently transmit short pulse light.

### Third Embodiment

A transmission apparatus 900 according to this embodiment will be described with reference to FIG. 9A. FIG. 9A is a diagram describing the configuration of the transmission apparatus 900. In the first embodiment, the laser (short pulse light) 102 is input from the transmission apparatus 100 into the photoconductive element 106. In this embodiment, however, the laser pulse 102 from the light source 101 is input into a nonlinear optical element 906 (hereinafter referred to as an “element 906”) for generating a terahertz wave. The transmission apparatus 900 includes a negative dispersion medium 903 (hereinafter referred to as a “medium 903”), a first fiber (negative dispersion fiber) 904, and a second fiber (positive dispersion fiber) 905. The detailed description of the configuration of the transmission apparatus 900 similar to that described in the first embodiment will be omitted.

FIG. 9B is a diagram describing the configuration of the element 906. The element 906 includes a waveguide 907 including nonlinear crystal (nonlinear optical crystal) as a core layer and a connecting member 908. The connecting member 908 is made of silicon and has a flat surface and a curved surface of a cone. The connecting member 908 is disposed so that the flat portion of the connecting member 908 is close to the waveguide 907. The rotation axis of the cone is the same as the central axis of the core layer of the waveguide 907. The height of the cone is substantially the same as the length of the waveguide 907.

When the laser pulse 102 propagates through the nonlinear crystal in the waveguide 907, a terahertz wave is generated by an optical rectification effect that is a secondary nonlinear optical effect. The generated terahertz wave is output from the waveguide 907, propagates through the connecting member 908 close to the waveguide 907, and emits from the side surface of the cone. This phenomenon is called electrooptical Cerenkov radiation, and is known as a high-intensity terahertz wave generation method using a large nonlinear optical effect. Since the cross-sectional area of the nonlinear optical crystal in the waveguide 907 is small, a high light density can be obtained. For more details on this phenomenon, see IEEE Select. Topic. In Quantum Electron, Vol. 19, p. 8500212, (2013).

Light output from the positive dispersion fiber 905 enters the waveguide 907. The waveguide 907 is typically designed so that the laser pulse 102 propagates in a single mode and the core portion of the waveguide 907 has a cross-section with the diameter (core diameter) of approximately 10 μm. As the nonlinear crystal, lithium niobate (LiNbO₃) is used. Alternatively, as the nonlinear crystal, LiTaOx, NaTaOx, KTP, ZnTe, GaSe, or GaAs may be used.

LiNbO₃ has unique dispersion characteristics. While the laser pulse 102 enters the waveguide 907 and propagates through the waveguide 907, the pulse width of the laser pulse 102 is increased. Since the electrooptical Cerenkov radiation uses a secondary nonlinear optical effect, the decrease in peak power due to the increase in a pulse width leads to the decrease in the intensity of a generated terahertz wave. In order to increase the intensity of a generated terahertz wave, it is desired that the lengths of the medium 903, the negative dispersion fiber 904, and the positive dispersion fiber 905 be set so that the pulse width of the laser pulse 102 becomes the shortest at the midpoint of the waveguide 907 (at a 5-mm distance from the incident end of the waveguide 907).

The medium 903, the negative dispersion fiber 904, and the positive dispersion fiber 905 are made of the same respective materials as those described in the first embodiment. The medium 903, the negative dispersion fiber 904, and the positive dispersion fiber 905 therefore need to have respective lengths different from those described in the first embodiment.

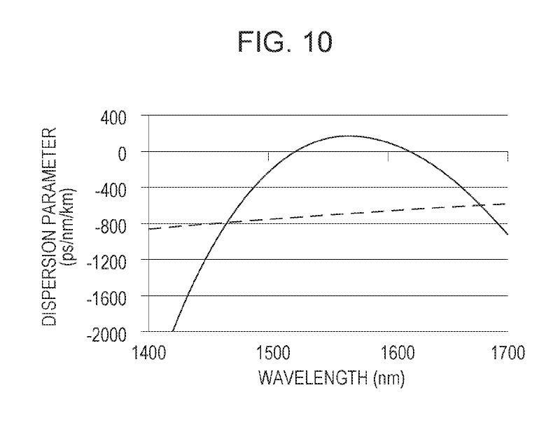

The dispersion characteristics of LiNbO₃ can be calculated with a Sellmeier's equation. At the wavelength of 1550 nm, its dispersion parameter is 78.30 ps/nm/km and its dispersion slope is 0.305 ps/nm/km. In a case where the lengths of the medium 903, the negative dispersion fiber 904, and the positive dispersion fiber 905 are set to 10 mm, 50 mm, and 970 mm, respectively, the total amount of dispersions including the dispersion of lithium niobate with the length of 5 mm is illustrated in FIG. 10. As illustrated in FIG. 10, in the entire spectral range of the laser pulse 102, compensation for dispersion is performed.

Thus, the transmission apparatus 900 according to this embodiment can reduce dispersion of an optical fiber and the influence of a nonlinear optical effect and efficiently transmit short pulse light.

### Fourth Embodiment

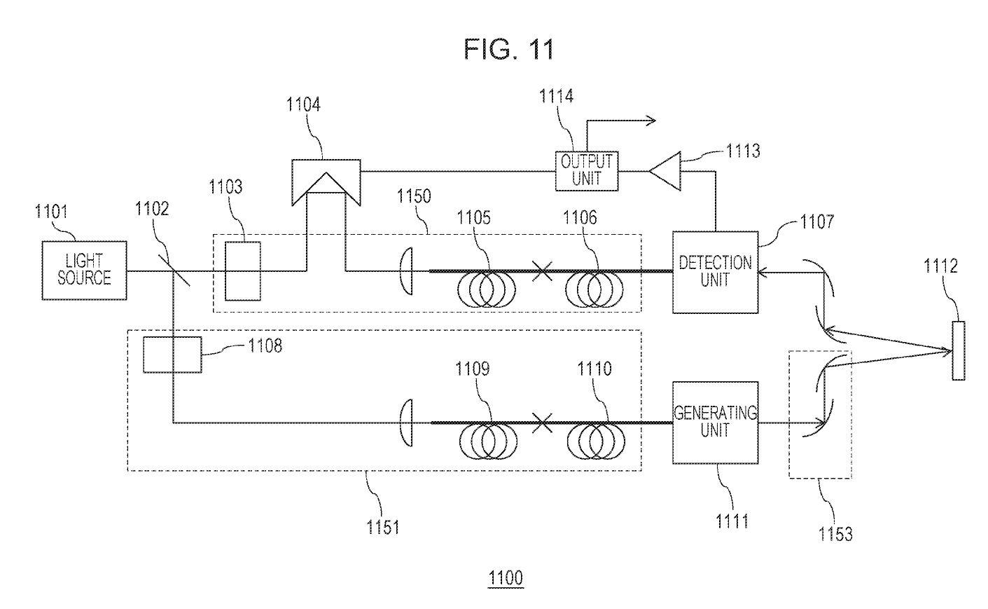

An information acquisition apparatus 1100 according to this embodiment will be described with reference to FIG. 11. FIG. 11 is a diagram describing the configuration of the information acquisition apparatus 1100. The information acquisition apparatus 1100 is a measurement apparatus for acquiring the temporal waveform of a terahertz wave pulse (hereinafter referred to as a “terahertz wave”) reflected from a specimen 1112. The information acquisition apparatus 1100 performs measurement using the principle of the Terahertz Time Domain Spectroscopy (THz-TDS method).

The information acquisition apparatus 1100 includes a light source 1101, a beam splitter 1102, a delay optical unit 1104, a detection unit 1107, a generating unit 1111, an amplification unit 1113, an output unit 1114, a transmission devices 1150 and 1151, and an irradiation unit 1153. The beam splitter 1102 splits short pulse light from the light source 1101 into pump light to enter the generating unit 1111 and probe light to enter the detection unit 1107.

The transmission device 1151 is a first transmission unit for transmitting pump light to the generating unit 1111, and includes a first negative dispersion medium 1108 (hereinafter referred to as a “first medium 1108”), a first negative dispersion fiber 1109, and a first positive dispersion fiber 1110. The transmission device 1150 is a second transmission unit for transmitting probe light to the detection unit 1107, and includes a second negative dispersion medium 1103 (hereinafter referred to as a “second medium 1103”), a second negative dispersion fiber 1105, and a second positive dispersion fiber 1106. Each of the first medium 1108, the second medium 1103, the first negative dispersion fiber 1109, the second negative dispersion fiber 1105, the first positive dispersion fiber 1110, and the second positive dispersion fiber 1106 has the same characteristics as that described in the first embodiment, and the length thereof is set using the method described in the first embodiment.

In a case where the lengths of the second medium 1103 and the first medium 1108 are the same, the second medium 1103 and the first medium 1108 may be removed and a single medium may be disposed between the light source 1101 and the beam splitter 1102.

A voltage signal output from a voltage source (not illustrated) is applied to a photoconductive element that is the generating unit 1111. Pump light is transmitted from the first positive dispersion fiber 1110 to the generating unit 1111, so that a terahertz wave is generated. The generating unit 1111 generates a terahertz wave on receipt of light, and is a photoconductive element in this embodiment. As the generating unit 1111, for example, a terahertz wave generating element using a nonlinear crystal such as the element 906 described in the third embodiment may be used. The terahertz wave generated by the generating unit 1111 is directed at the specimen 1112, is reflected from the specimen 1112, and reaches the detection unit 1107.

The detection unit 1107 detects the terahertz wave using probe light output from the second positive dispersion fiber 1106. In this embodiment, as the detection unit 1107, a photoconductive element is used. When probe light enters the detection unit 1107 while a terahertz wave enters the detection unit 1107, a current is obtained as a terahertz wave detection signal. The obtained current is converted into a voltage signal by the amplification unit 1113 and is then transmitted to the output unit 1114.

By applying an alternating voltage signal to the generating unit 1111, the terahertz wave generated by the generating unit 1111 may be subjected to intensity modulation and lock-in detection of a detection signal in the detection unit 1107 may be performed. As an intensity modulation unit for a terahertz wave, a chopper may be used. The chopper may modulate pump light before the pump light enters the first negative dispersion fiber 1109.

The delay optical unit 1104 optically adjusts intervals (delay times) at which a terahertz wave enters the detection unit 1107 by changing the difference between the optical path length of pump light and the optical path length of probe light. By measuring a terahertz wave detected by the detection unit 1107 while changing a delay time, the measurement of a temporal waveform using the THz-TDS method is performed. By causing the output unit 1114 to control the delay optical unit 1104 to change a delay time and plotting the signals of a terahertz wave obtained by the detection unit 1107 at delay intervals, the temporal waveform of the terahertz wave can be obtained.

The information acquisition apparatus 1100 detects a terahertz wave reflected from the specimen 1112, but may detect a terahertz wave that has passed through the specimen 1112.

In order to change a position (irradiation position) on the specimen 1112 at which a terahertz wave is directed, a stage for moving the specimen 1112 may be disposed in a direction perpendicular to a terahertz wave parallel propagation region and the specimen 1112 may be moved at appropriate time intervals. The “terahertz wave parallel propagation region” is wave-optically defined as the depth of focus of a terahertz wave that has been concentrated onto the specimen 1112 by the irradiation unit 1153. The “depth of focus” is defined as a range in which, in a case where the irradiation unit 1153 reduces the diameter of a laser beam, the beam diameter of the laser is equal to or smaller than w×√2 where w represents the minimum beam diameter.

With this configuration, it is also possible to perform imaging in which the image of the specimen 1112 is acquired using analysis results of temporal waveforms obtained at respective irradiation positions. More specifically, using data on the temporal waveform of a terahertz wave acquired at each terahertz wave irradiation position, an imaging view can be acquired on the basis of the shape and peak value of the temporal waveform, an amplitude spectrum and a phase spectrum obtained by a Fourier transform, and a complex index of refraction.

The information acquisition apparatus 1100 according to this embodiment transmits pump light and probe light with optical fibers. In a case where the dispersion of the optical fibers and the influence of a nonlinear optical effect are large, the pulse widths of the pump light and the probe light are increased and the peak power of the ump light and the probe light is reduced. This leads to the narrowing of a terahertz wave spectrum and the reduction in peak power of a terahertz wave. Using the transmission devices 1150 and 1151, it is possible to reduce the dispersion of pump light and probe light in optical fibers and the influence of a nonlinear optical effect and efficiently transmit the pump light and the probe light. It is therefore possible to suppress the narrowing of a terahertz wave spectrum and the reduction in peak power of a terahertz wave.

In this embodiment, both of the first transmission unit and the second transmission unit are transmission apparatuses according to the above-described embodiment. However, one of them may be a transmission apparatus according to the above-described embodiment. Furthermore, the first transmission unit and the second transmission unit may transmit pulse lights from different light sources.

### Fifth Embodiment

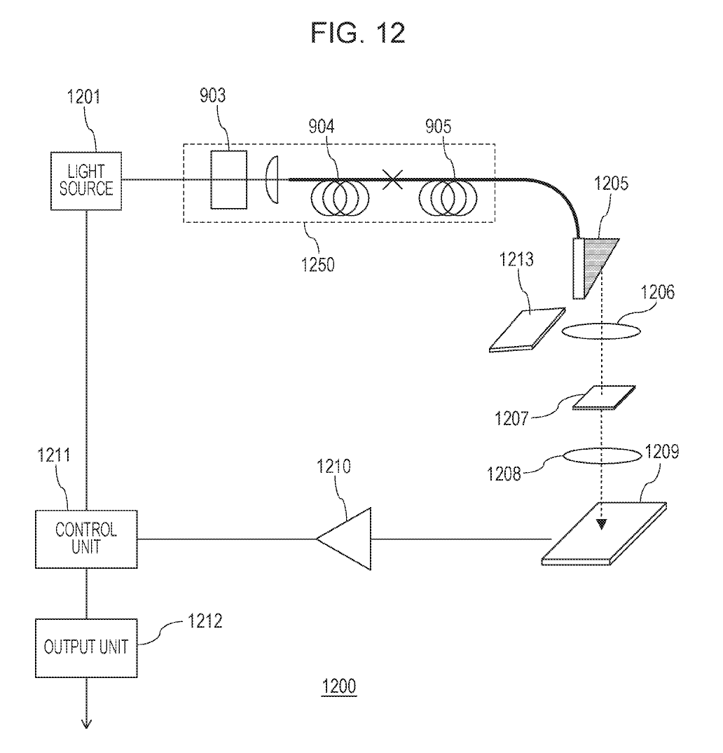

An information acquisition apparatus 1200 according to this embodiment will be described with reference to FIG. 12. FIG. 12 is a diagram describing the configuration of the information acquisition apparatus 1200. The information acquisition apparatus 1200 is an imaging system for acquiring the image of a specimen 1207. The information acquisition apparatus 1200 includes a light source 1201, a transmission device 1250, a generating unit 1205, lenses 1206 and 1208, a detection unit 1209, an amplifier 1210, a control unit 1211, and an output unit 1212.

The generating unit 1205 is a generating element for generating a terahertz wave using nonlinear crystal. The generating unit 1205 has the same configuration as that of the element 906 described in the third embodiment. The generating unit 1205 generates a terahertz wave (terahertz wave pulse) upon receipt of light from the transmission device 1250 and outputs the terahertz wave by the electrooptical Cerenkov radiation. As the transmission device 1250, the transmission apparatus 900 according to the third embodiment is used. That is, the transmission device 1250 includes the medium 903, the negative dispersion fiber 904, and the positive dispersion fiber 905. The lengths of these components are set in consideration of dispersion of the waveguide 907.

A terahertz wave generated by the generating unit 1205 is concentrated onto the specimen 1207 by the lens 1206. The terahertz wave that has passed through the specimen 1207 enters the detection unit 1209 via the lens 1208. The lenses 1206 and 1208 are optical systems for concentrating a terahertz wave. On the basis of the spatial extension of a terahertz wave and the size of the detection unit 1209, the number of lenses may be set. Instead of the lenses 1206 and 1208, parabolic mirrors may be used.

The detection unit 1209 detects an average output of terahertz waves that have passed through the specimen 1207. As the detection unit 1209, Schottky barrier diode-type, plasmon-type, FET-type, pyro-type, or bolometer-type electronic device can be used. Since a terahertz wave obtained in this embodiment is a subpicosecond pulse, the detection unit 1209 cannot measure the temporal waveform of the terahertz wave. The repetition frequency of a terahertz wave pulse is, for example, 80 MHz. The detection unit 1209 measures the time average of the intensity of a terahertz wave.

In order to measure the time average, the measurement band of the detection unit 1209 needs to be sufficiently small, for example, be equal to or less than 10 MHz that is substantially one-tenth of a laser repetition frequency. In a case where a detector having a narrow measurement band such as a pyro-type detector is used as the detection unit 1209, a measurement signal is used without being processed. In a case where, for example, a diode is used, a band adjustment unit such as an integrator or a low-pass filter is disposed to process a signal output from a detector.

As the detection unit 1209, a detector having a two-dimensional array with a plurality of detection elements may be used to measure, for example, an output terahertz wave or a scattering pattern. In order to detect the backscattering or reflection of a terahertz wave, another detection unit 1213 may be used. In order to enhance an S/N ratio, the control unit 1211 may transmit a command signal to the light source 1201 to perform intensity modulation upon an output light. In order to perform intensity modulation upon a terahertz wave and perform lock-in detection, a chopper may be used in a spatial optical unit.

A detection result of the detection unit 1209 is amplified by the amplifier 1210 and is then transmitted to the output unit 1212 via the control unit 1211. The control unit 1211 controls each component in the information acquisition apparatus 1200. The output unit 1212 acquires the temporal waveform of a terahertz wave using the detection result of the detection unit 1209, acquires information about the specimen 1207 by analyzing the acquired temporal waveform, and acquires the image of the specimen 1207 using the acquired information about the specimen 1207.

In this embodiment, the position of the specimen 1207 is fixed. However, an object moving unit such as a stage or a conveyor belt for moving the specimen 1207 may be disposed. From the combination of a terahertz wave irradiation position on the specimen 1207 and an output signal that is the detection result of the detection unit 1209, a one-dimensional or two-dimensional imaging view can be acquired.

The information acquisition apparatus 1200 according to this embodiment transmits light with an optical fiber in the transmission device 1250. In a case where the dispersion of the optical fiber and the influence of a nonlinear optical effect are large, the pulse widths of pump light and probe light may be increased and the peak power of pump light and probe light may be therefore reduced. This leads to the narrowing of a spectrum of a terahertz wave and the reduction in the peak power of a terahertz wave. Using the transmission device 1250, it is possible to reduce the dispersion of the optical fiber and the influence of a nonlinear optical effect and efficiently transmit light. It is therefore possible to suppress the narrowing of a spectrum of a generated terahertz wave and the reduction in the peak power of the terahertz wave.

Embodiments of the present invention have been described, but the present invention is not limited to these embodiments. Various modifications and changes can be made to the embodiments within the scope of the present invention. For example, by making changes to the embodiments, the present invention can be applicable to various uses in which the transmission of short-pulse laser light through an optical fiber is performed. Examples of the range of application of the present invention other than a terahertz wave generator include a microscope, a medical apparatus, and a pulse processing apparatus. The present invention can also be applied to a terahertz wave generation/detection apparatus obtained by modularizing a transmission device according to an embodiment of the present invention and an element for generating or detecting an electromagnetic wave such as a terahertz wave. As the element for generating or detecting an electromagnetic wave, an element that includes nonlinear crystal and uses electrooptical Cerenkov radiation or a known element such as a photoconductive element that generates an electromagnetic wave upon receipt of pulse light can be used.

In the above-described embodiments, optical fibers such as the first fiber and the second fiber are used. These optical fibers do not necessarily have to include a core portion and a clad portion. For example, a light waveguide member that does not include a clad portion and guides light by confining light in a plane perpendicular to a light propagation direction and having a refractive-index distribution is also an example of the first fiber or the second fiber according to an embodiment of the present invention. In this case, a central part of the light waveguide member having a higher refractive index than a peripheral part corresponds to a core portion of an optical fiber.

While the present invention has been described with reference to exemplary embodiments, it is to be understood that the invention is not limited to the disclosed exemplary embodiments. The scope of the following claims is to be accorded the broadest interpretation so as to encompass all such modifications and equivalent structures and functions.

This application claims the benefit of Japanese Patent Applications No. 2015-054061, filed Mar. 17, 2015, and No. 2016-011850, filed Jan. 25, 2016 which are hereby incorporated by reference herein in their entirety.

What is claimed is:

1. An optical transmission apparatus for transmitting pulsed light, comprising:
a dispersion medium configured to transmit incident pulsed light and having a negative dispersion parameter in a wavelength band of the incident pulsed light;
a first fiber which receives the pulsed light that has passed through the dispersion medium and has a negative dispersion parameter in a wavelength band of the incident pulsed light; and
a second fiber which receives the pulsed light that has passed through the first fiber and has a positive dispersion parameter in a wavelength band of the incident pulsed light,
wherein the dispersion medium and the second fiber have positive dispersion slopes, and
wherein the first fiber has a negative dispersion slope.

2. The optical transmission apparatus according to claim 1,
wherein the dispersion medium is configured to satisfy Expressions (1), (2), (3) and (4),
LD<LNL (1)
$${L}_{D} = \frac{{T}_{0}^{2}}{{b}_{2}} \qquad ( 2 )$$
where T₀ represents a pulse width of pulsed light that enters the dispersion medium,
b₂ represents group velocity dispersion per unit length of the first fiber,
P₀ represents peak power of pulsed light that enters the dispersion medium,
P₁ represents peak power of pulsed light that has just passed through the dispersion medium,
γ represents a nonlinear coefficient of the first fiber,
L₁ represents a length of the dispersion medium in a direction of an optical axis of the pulsed light that enters the dispersion medium, and
b_{nd} represents group velocity dispersion per unit length of the dispersion medium, and
wherein, in a frequency range of the pulsed light that enters the dispersion medium, a total amount of dispersions b₂ₐₗₗ is smaller than the pulse width T₀ of the pulsed light that enters the dispersion medium.

3. The optical transmission apparatus according to claim 1,
wherein the first fiber and the second fiber are single-mode fibers, and
wherein a zero dispersion wavelength of the first fiber is longer than a zero dispersion wavelength of the second fiber.

4. The optical transmission apparatus according to claim 1, wherein a zero dispersion wavelength of the second fiber is shorter than a wavelength of the pulsed light that enters the dispersion medium.

5. The optical transmission apparatus according to claim 1, wherein a pulse width of pulsed light that enters the dispersion medium is equal to or less than 100 femtoseconds.

6. The optical transmission apparatus according to claim 1, further comprising:
an optical unit configured to concentrate pulsed light onto the dispersion medium to enter the pulsed light into the dispersion medium; and
a casing in which the dispersion medium and the optical unit are disposed,
wherein the casing and the first fiber are connected.

7. The optical transmission apparatus according to claim 6, wherein the casing is connected to an output fiber of a light source that outputs pulsed light to the dispersion medium.

8. The optical transmission apparatus according to claim 1, wherein the dispersion medium contains silicon.

9. The optical transmission apparatus according to claim 1, wherein the first fiber and the second fiber contain silicon dioxide.

10. An information acquisition apparatus to acquire information about a specimen, comprising:
a generating unit configured to generate a terahertz wave upon receipt of pulsed light;
an irradiation unit configured to irradiate the specimen with a terahertz wave generated by the generating unit; and
a detection unit configured to detect a terahertz wave from the specimen; and
a transmission unit configured to transmit pulsed light output from a light source to the generating unit or to the detection unit,
wherein the transmission unit is the optical transmission apparatus according to claim 1.

11. An apparatus for generating or detecting a terahertz wave comprising:
the optical transmission apparatus according to claim 1, and
an element configured to generate or detect a terahertz wave upon receipt of pulsed light from the optical transmission apparatus.

12. The apparatus according to claim 11, wherein the element includes a photoconductive element.

13. The apparatus according to claim 11, wherein the element contains nonlinear crystal.
